(19) United States
(12) Patent Application Publication
(10) Pub. No.: US 2026/0016323 A1
(43) Pub. Date: Jan. 15, 2026

(54) STRUCTURE CAPABLE OF AUTOMATICALLY IDENTIFYING INSERTED/PULLED-OUT STATE OF MASSAGE HEAD

(71) Applicant: Zhejiang Red And Black Technology Co., Ltd., Lishui (CN)

(72) Inventors: Xinyi Shu, Jinyun (CN); Lifeng Shu, Jinyun (CN)

(21) Appl. No.: 18/822,116

(22) Filed: Aug. 31, 2024

(30) Foreign Application Priority Data
Jul. 9, 2024 (CN) 2024216205227

(51) Int. Cl. G01D 5/34; A61H 37/00

(52) U.S. Cl. CPC G01D 5/342; A61H 37/00; A61H 2201/0107; A61H 2201/5064; A61H 2201/5092

(57) ABSTRACT

A structure capable of automatically identifying an inserted/pulled-out state of a massage head includes a sliding rod, a plastic support and a sensor. The sliding rod is provided with a notch. The plastic support is provided with two positionally symmetrical supporting rods, and the supporting rods fit with the notch. The plastic support is further provided with a mounting portion, the mounting portion is provided with a printed circuit board assembly (PCBA) and a sensor, and the PCBA is in circuit connection with the sensor. When the massage head is fastened to the sliding rod, the sensor is triggered. The sensor and the PCBA are arranged in the plastic support and the plastic support and the sliding rod are positionally limited, so that displacement of the sensor and the PCBA in the plastic support is avoided, and stability of signal detection by the sensor is improved.

### TECHNICAL FIELD

The present disclosure relates to the field of massage devices, and in particular, to a structure capable of automatically identifying an inserted/pulled-out state of a massage head.

### BACKGROUND

In existing massage devices, especially those with insertable massage heads, in order to improve user experience and an intelligent level of the devices, it is usually necessary to automatically identify whether the massage heads are correctly mounted or inserted or pulled out.

However, in the prior art, this automatic identification function is often faced with some challenges. Because the massage device may be affected by external factors such as vibration and shaking during use, a sensor and a related circuit thereof that are mounted on the device are prone to displacement or looseness due to these external factors, which leads to a decline in accuracy of signals detected by the sensor and even misjudgment.

### SUMMARY

In view of the above situation, it is necessary to provide a structure capable of automatically identifying an inserted/pulled-out state of a massage head to solve at least one of the above problems, including a sliding rod, a plastic support and a sensor, where the sliding rod is provided with a notch, the plastic support is provided with two positionally symmetrical supporting rods, each supporting rods fit with the notch, the plastic support is further provided with a mounting portion, the mounting portion is provided with a printed circuit board assembly (PCBA) and a sensor, the PCBA is in circuit connection with the sensor, and when the massage head is fastened to the sliding rod, the sensor is triggered.

Preferably, a through hole is provided at a center of the mounting portion.

Preferably, the PCBA is provided with a plurality of limiting holes, first limiting rods are arranged on two sides of the through hole, and when the PCBA is placed at the mounting portion, the first limiting rods are opposite to the limiting holes.

Preferably, the first limiting rod and the supporting rod are both hollow.

Preferably, the sensor includes a micro switch, the micro switch is clamped in the through hole, and an elastic sheet of the micro switch faces the massage head.

Preferably, the micro switch is provided with welding pins, and the welding pins match the limiting holes.

Preferably, the sensor includes a photosensitive sensor, and the photosensitive sensor is attached to the PCBA and is located in the through hole.

### BRIEF DESCRIPTION OF THE DRAWINGS

1. Sliding rod; 11. Notch; 2. Plastic support; 21. Supporting rod; 22. Mounting portion; 221. Through hole; 222. First limiting rod; 3. Sensor; 31. Micro switch; 311. Welding pin; 32. Photosensitive sensor; 4. PCBA; 41. Limiting hole; 5. Massage head.

FIG. 1 is a schematic structural diagram illustrating connection between a massage head and a sliding rod according to an embodiment of the present disclosure;

FIG. 2 is an exploded view illustrating connection between a massage head and a sliding rod according to an embodiment of the present disclosure;

FIG. 3 is a schematic structural diagram illustrating connection of a sliding rod according to an embodiment of the present disclosure;

FIG. 4 is an exploded view of a photosensitive sensor and a plastic support according to an embodiment of the present disclosure;

FIG. 5 is an exploded view of a micro switch and a plastic support according to an embodiment of the present disclosure; and

FIG. 6 is a sectional view of a massage head and a sliding rod according to an embodiment of the present disclosure.

### DETAILED DESCRIPTION OF THE EMBODIMENTS

To make the objectives, technical solutions and the advantages of the present disclosure clearer, a structure capable of automatically identifying an inserted/pulled-out state of a massage head according to the present disclosure is described in further detail below with reference to the accompanying drawings and embodiments. It should be understood that specific embodiments described herein are merely intended to explain the present disclosure, but are not intended to limit the present disclosure.

In the description of the present disclosure, unless otherwise specified, “a plurality of” means two or more. The directional or positional relationship indicated by the term such as “central”, “longitudinal”, “transverse”, “upper”, “lower”, “left”, “right”, “inside”, “outside”, “front end”, “rear end”, “head”, “tail”, “vertical”, “horizontal”, “top”, and “bottom” is the directional or positional relationship based on the accompanying drawings, and is merely intended to facilitate and simplify the description of the present disclosure, rather than to indicate or imply that the device or element referred to must have a particular direction and be constructed and operated in a particular direction. Therefore, this should not be construed as limiting the present disclosure. In addition, the terms “first”, “second” and “third” are for descriptive purposes only and should not be construed as indicating or implying relative importance.

In the description of the present disclosure, it should be noted that, unless otherwise clearly specified, meanings of terms “mount”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

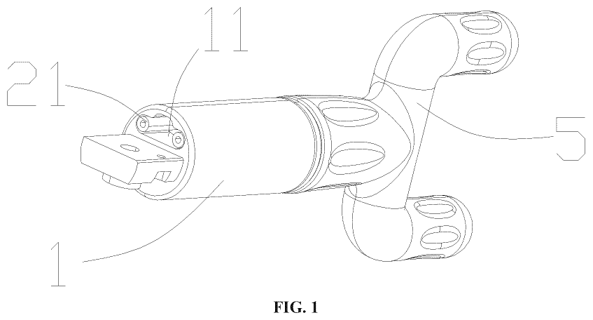

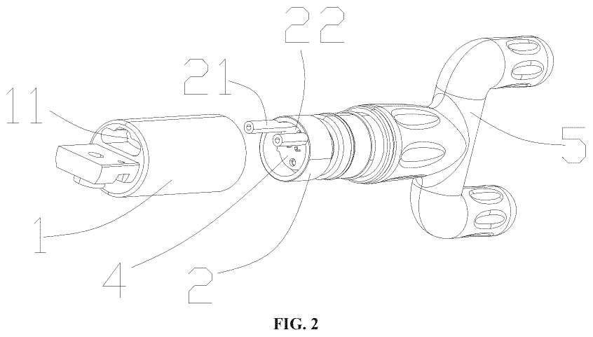

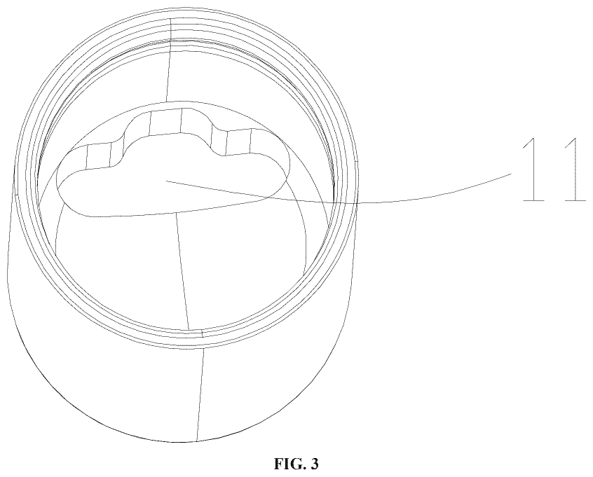

Referring to FIGS. 1 to 6, a structure capable of automatically identifying an inserted/pulled-out state of a massage head 5 includes a sliding rod 1, a plastic support 2 and a sensor 3. The sliding rod 1 is provided with a notch 11, and the plastic support 2 is provided with two positionally symmetrical supporting rods 21. The supporting rods 21 fit with the notch 11. The plastic support 2 is further provided with a mounting portion 22. The mounting portion 22 is provided with a PCBA 4 and a sensor 3, and the PCBA 4 is in circuit connection with the sensor 3. When the massage head 5 is fastened to the sliding rod 1, the sensor 3 is triggered.

In the above embodiment, the notch 11 provided in the sliding rod 1 is designed to receive and guide the supporting rod 21 in the plastic support 2. This design of fit between the notch 11 and the supporting rod 21 has an effect of limiting the plastic support 2, so as to prevent the plastic support 2 from swaying from side to side during starting of a machine and affecting a detection effect of the sensor 3. As the plastic support 2 is used as a key component for connecting the massage head 5 to the PCBA 4, the supporting rods 21 symmetrically arranged on two sides of the plastic support are precisely inserted into the notch 11 of the sliding rod 1, thereby implementing the stable connection of the structure. In addition, the mounting portion 22 on the plastic support 2 integrates the PCBA 4 and the sensor 3. This layout optimizes space utilization. The sensor 3 can transmit an electrical signal to a main control system through the PCBA 4, thereby ensuring fast and accurate signal transmission. As a core detection element of the entire structure, the sensor 3 is mounted in the mounting portion 22 and is welded to the PCBA 4. The sensor 3 is in circuit connection to a main control system through the PCBA 4. When the massage head 5 is properly fastened to the sliding rod 1, this physical contact action triggers a sensing mechanism inside the sensor 3. After receiving a signal from the sensor 3, the main control system immediately makes a logical judgment to confirm whether the massage head 5 has been properly mounted in place. This process implements the automatic flow from physical contact to electrical signal conversion, and then to logical processing, and the inserted/pulled-out state of the massage head 5 can be accurately identified without manual intervention. To sum up, in this structure, the inserted/pulled-out state of the massage head 5 is automatically identified through mechanical fit between the sliding rod 1 and the plastic support 2 and electronic linkage between the sensor 3 and the main control system, which provides important support for the intelligent control of a massage device.

Referring to FIGS. 1 to 6, a through hole 221 is provided at a center of the mounting portion 22.

In the above embodiment, since the massage head 5 is linearly mounted on the sliding rod 1, this mounting method requires that the circuit connection between the sensor 3 and the PCBA 4 must be smooth and efficient. The design of the through hole 221 allows a circuit wire to pass therethrough, which reduces the complexity of the circuit layout, facilitates direct circuit communication between the sensor 3 and the PCBA 4, and improves efficiency and stability of signal transmission. In addition, the through hole 221 also facilitates detection of the state of the massage head 5 by the sensor 3. The sensor 3 usually needs to sense relative positions of or physical contact between the massage head 5 and the sliding rod 1 in some way. The through hole 221 allows the sensor 3 to directly face a mounting position of the massage head 5, and provides a necessary space for the sensor 3 to mount the detection element, so as to detect the inserted/pulled-out state of the massage head 5 more accurately.

Referring to FIGS. 1 to 6, the PCBA 4 is provided with a plurality of limiting holes 41, first limiting rods 222 are arranged on two sides of the through hole 221, and when the PCBA 4 is placed at the mounting portion 22, the first limiting rods 222 are opposite to the limiting holes 41.

In the above embodiment, when the PCBA 4 is placed at the mounting portion 22, the first limiting rods 222 on the two sides of the through hole 221 correspond to the limiting holes 41 in the PCBA 4. This design allows the limiting rods to penetrate into the limiting hole 41 to form a physical locking mechanism, thereby effectively preventing the PCBA 4 from shaking or dislocating in the mounting portion 22. This structural principle not only ensures mounting stability of the PCBA 4, but also simplifies the mounting process and improves overall assembly efficiency and reliability.

Referring to FIGS. 1 to 6, the first limiting rod 222 and the supporting rod 21 are both hollow.

In the above embodiment, the hollow design not only reduces the weight of the structure, but also allows a limiting pin to be inserted therein. When the PCBA 4 or the plastic support 2 is mounted in place, the limiting pin can pass through a hollow portion and be locked at a preset position, thereby further enhancing a limiting effect and ensuring stability and accuracy of the structure.

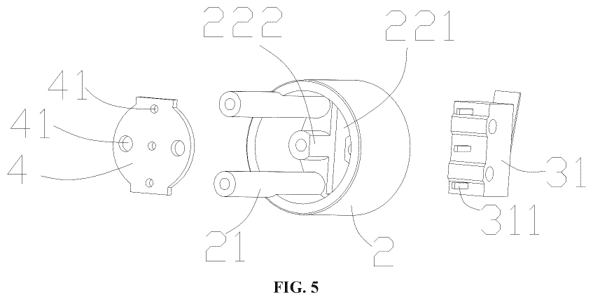

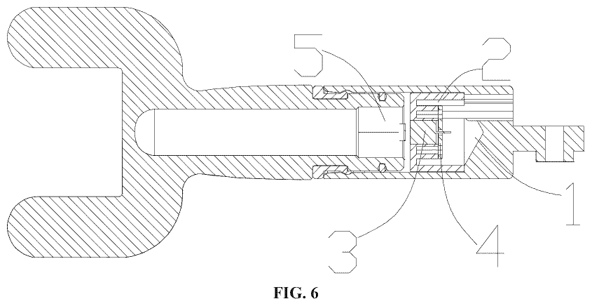

Referring to FIGS. 5 and 6, the sensor 3 includes a micro switch 31, and the micro switch 31 is clamped in the through hole 221. An elastic sheet of the micro switch 31 faces the massage head 5.

In the above embodiment, the elastic sheet of the micro switch 31 is designed to face the massage head 5. When the massage head 5 is fastened to the sliding rod 1, the elastic sheet is triggered to displace, thereby closing or disconnecting a switch contact. This process converts physical contact into electrical signal changes, which are transmitted to the PCBA 4 through a circuit, and the PCBA 4 transmits the changes to the main control system for processing.

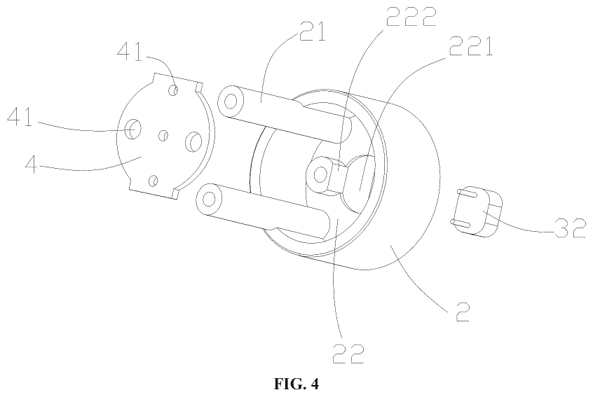

Referring to FIGS. 4 and 6, the micro switch 31 is provided with welding pins 311, and the welding pins 311 match the limiting holes 41.

In the above embodiment, when the micro switch 31 is clamped in the through hole 221, the welding pins 311 are naturally aligned and inserted into the limiting holes 41 to forming physical locking. In this design, the micro switch 31 is prevented from shifting or loosening during mounting, and it is ensured that the elastic sheet of the micro switch can be accurately aligned and respond to an action of the massage head 5.

Referring to FIGS. 1 to 6, the sensor 3 includes a photosensitive sensor 32, and the photosensitive sensor 32 is attached to the PCBA 4 and is located in the through hole 221.

In the above implementation, when the massage head 5 is at a specific position, a light path at the through hole 221 is blocked or changed, thereby affecting an optical signal received by the photosensitive sensor 32. The photosensitive sensor 32 converts this optical signal change into an electrical signal, which is transmitted to the PCBA 4 through a circuit, and the PCBA 4 transmits the signal to the main control system for processing. This non-contact detection method avoids mechanical wear, improves durability and accuracy of the system, simplifies the structure, and makes the overall design more compact.

The above descriptions are only preferred embodiments of the present disclosure, and are not intended to limit the present disclosure in any form. Although the present disclosure has been disclosed by the preferred embodiments above, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification and equivalent change made to the foregoing embodiments according to the technical essence of the present disclosure without departing from the content of the technical solution of the present disclosure shall fall within the scope of the technical solution of the present disclosure.

What is claimed is:

1. A structure capable of automatically identifying an inserted/pulled-out state of a massage head, comprising a sliding rod, a plastic support and a sensor, wherein the sliding rod is provided with a notch, the plastic support is provided with two positionally symmetrical supporting rods, the supporting rods fit with the notch, the plastic support is further provided with a mounting portion, the mounting portion is provided with a printed circuit board assembly (PCBA) and a sensor, the PCBA is in circuit connection with the sensor, and when the massage head is fastened to the sliding rod, the sensor is triggered.

2. The structure capable of automatically identifying an inserted/pulled-out state of a massage head according to claim 1, wherein a through hole is provided at a center of the mounting portion.

3. The structure capable of automatically identifying an inserted/pulled-out state of a massage head according to claim 2, wherein the PCBA is provided with a plurality of limiting holes, first limiting rods are arranged on two sides of the through hole, and when the PCBA is placed at the mounting portion, the first limiting rods are opposite to the limiting holes.

4. The structure capable of automatically identifying an inserted/pulled-out state of a massage head according to claim 3, wherein the first limiting rod and the supporting rod are both hollow.

5. The structure capable of automatically identifying an inserted/pulled-out state of a massage head according to claim 2, wherein the sensor comprises a micro switch, the micro switch is clamped in the through hole, and an elastic sheet of the micro switch faces the massage head.

6. The structure capable of automatically identifying an inserted/pulled-out state of a massage head according to claim 2, wherein the micro switch is provided with welding pins, and the welding pins match the limiting holes.

7. The structure capable of automatically identifying an inserted/pulled-out state of a massage head according to claim 2, wherein the sensor comprises a photosensitive sensor, and the photosensitive sensor is attached to the PCBA and is located in the through hole.
